(19) United States
(12) Patent Application Publication
(10) Pub. No.: US 2008/0085687 A1
(43) Pub. Date: Apr. 10, 2008

(54) METHOD AND SYSTEM FOR ASSIGNING CALL WAITING PRIORITIES TO PHONE NUMBERS

(76) Inventors: Bobbi A. Brekke, Austin, TX (US); Michelle R. Cereceres, Austin, TX (US); Francisco Garcia, Manor, TX (US); Wendy Sue Korn, Austin, TX (US); David Nevarez, Austin, TX (US); Debora Velarde, Beaverton, OR (US); Marcos A. Villarreal, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/538,497

(22) Filed: Oct. 4, 2006

(51) Int. Cl. H04B 1/18

(52) U.S. Cl. 455/187.1

(57) ABSTRACT

A method for enabling a mobile phone to control the automatic activation/deactivation of the call waiting feature in real time through the use of customized pre-set user preferences. The mobile phone contains a database with multiple records for people and/or businesses known to the user. Within each record, the user may define a priority number. Each priority number is a scaled integer value, with low priority numbers representing a high priority record and high priority numbers representing low priority records. If the mobile phone detects an incoming call while a call is already in progress, a call waiting utility notifies the user of the incoming call if the incoming call corresponds to a preset priority number that is less than or equal to the priority number of the current call. Otherwise, the incoming call is directed to the user's voicemail system without interrupting the current call.

### BACKGROUND OF THE INVENTION

1. Technical Field

The present invention relates in general to the field of mobile phones and in particular to call notification features. Still more particularly, the present invention relates to an improved method and system for controlling the call waiting feature on mobile phones.

2. Description of the Related Art

Cellular telephones, also referred to as mobile phones, are portable electronic devices that enable users to communicate over long distances via a wireless medium. Conventional mobile phones utilize a network of base stations that are connected to the public switched telephone network (PSTN). Mobile phones typically include display components, logic components, such as digital signal processing (DSP) circuitry, and memory components. The memory components of mobile phones typically contain various software utilities, such as a graphical user interface (GUI), and user data, such as a phone book of numbers entered by the mobile phone user.

Mobile phones are equipped with numerous features, which are often provided in order to enhance performance and/or ease-of-use of the mobile phone. For example, the call waiting feature enables a mobile phone to notify a user who is currently making or engaged in a call that a second call is waiting to be answered. The user may then suspend the current call and switch to the second call. The call waiting feature therefore enables mobile phone users to field contemporary calls in parallel.

Mobile phone users may often consider some calls (i.e., calls originating from a particular number or person) as a “high priority” call and consider other calls “low priority” calls. During high-priority calls, a mobile phone user may not want to be interrupted or notified of other incoming low-priority calls. Conventional mobile phones allow users to turn off the call waiting feature, thereby blocking the notification of all incoming calls while a call is in progress. However users who deactivate the call waiting feature may thereby miss incoming high-priority calls. Consequently, an improved method and system for controlling the call waiting feature is needed.

### SUMMARY OF THE INVENTION

Disclosed is a method, system, and computer program product for enabling a mobile phone to control the automatic activation/deactivation of the call waiting feature in real time through the use of customized pre-set user preferences. The system memory of the mobile phone contains a database that includes multiple records for people and/or businesses known to the user. Within each record, the user may define a priority number. Each priority number is a scaled integer value, with low priority numbers representing phone book entries that have a high priority, and high priority numbers representing phone book numbers that have a low priority. If the mobile phone detects an incoming call while a call is already in progress, a call waiting utility notifies the user of the incoming call if the incoming call corresponds to a preset priority number that is less than or equal to the priority number of the current call. Otherwise, the incoming call is directed to the user's voicemail system without interrupting the current call.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of a mobile phone, as utilized in an embodiment of the present invention;

FIG. 2 depicts a high level block diagram of an exemplary phone book illustrating the prioritization of phone numbers, as utilized in an embodiment of the present invention; and

FIG. 3 is a high level logical flowchart of an exemplary method of enabling a mobile phone to control the automatic activation/deactivation of the call waiting feature in real time through the use of customized pre-set user preferences, in accordance with one embodiment of the invention.

### DETAILED DESCRIPTION OF AN ILLUSTRATIVE EMBODIMENT

The present invention provides a method, system, and computer program product for enabling a mobile phone to control the automatic activation/deactivation of the call waiting feature in real time through the use of customized, pre-set user preferences.

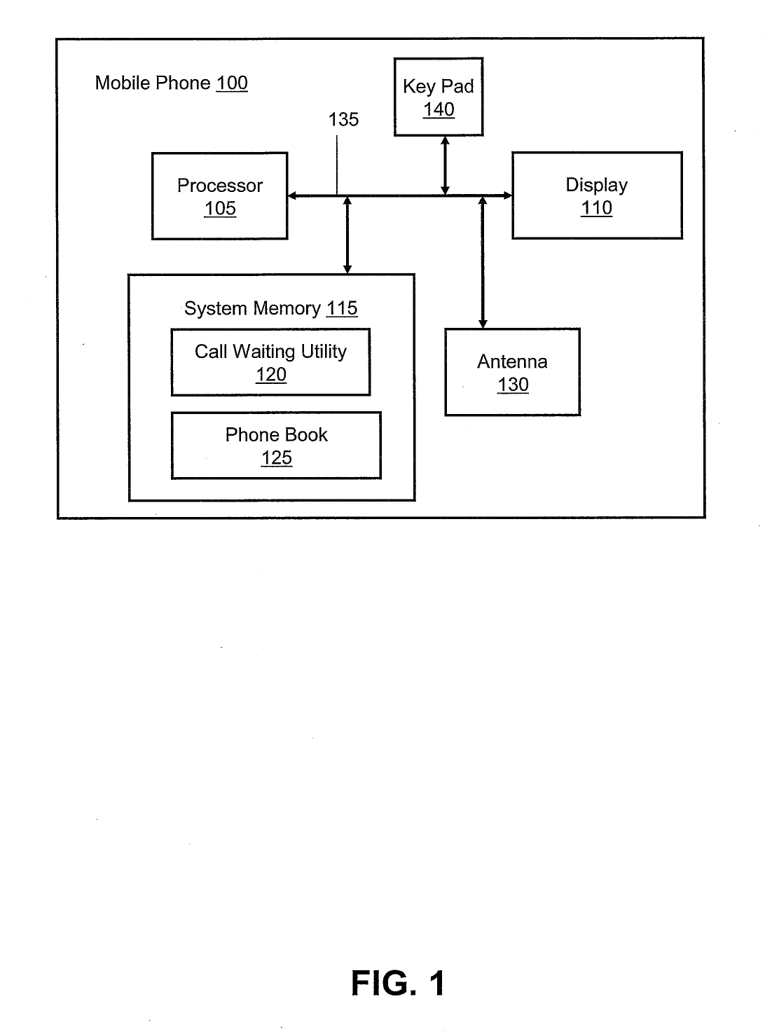

With reference now to FIG. 1, there is depicted a high level block diagram of a mobile phone, as utilized in an embodiment of the present invention. Mobile phone 100 comprises processor 105, display 110, system memory 115, and key pad 140, which are communicatively connected via system bus 135. Mobile phone 100 also includes antenna 130, which enables mobile phone 100 to transmit and receive data via a network of cellular base stations (not shown) controlled by a cellular telephone service provider. System memory 115 includes call waiting utility 120 and phone book 125.

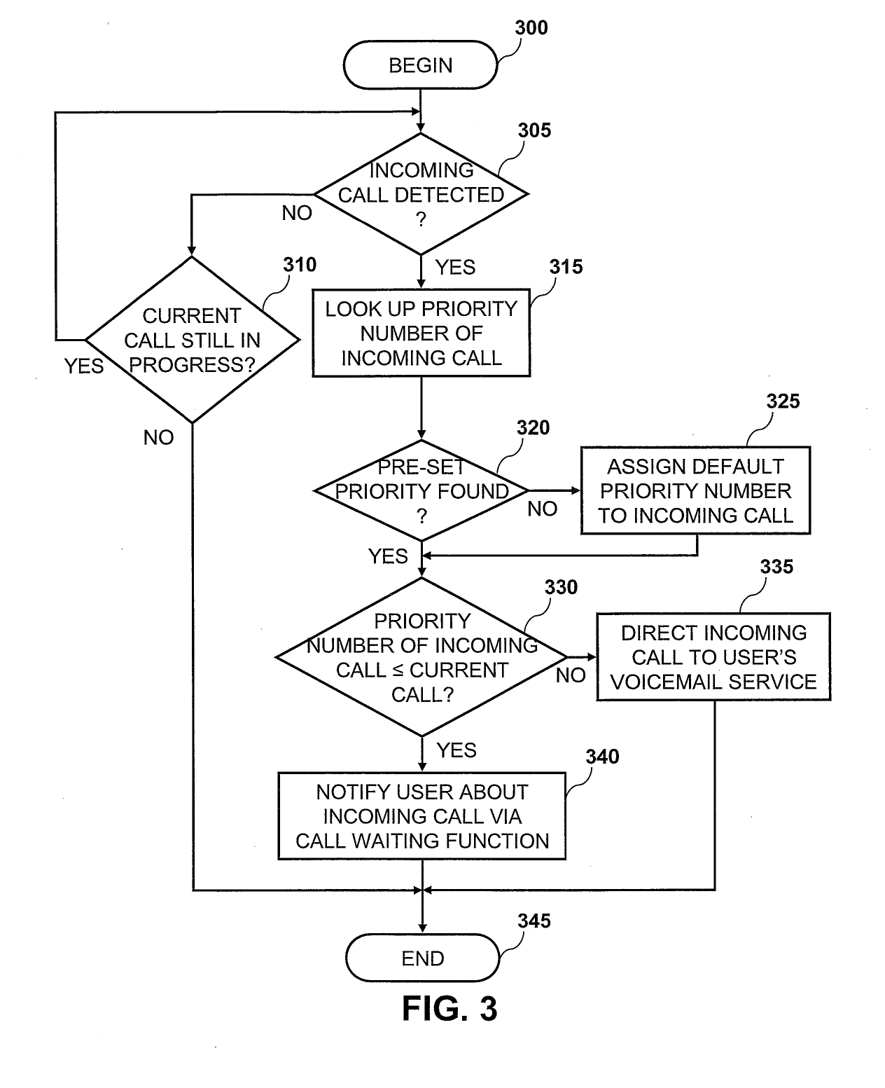

According to the illustrative embodiment, call waiting utility 120 is a software program that performs the functions of the present invention in order to enable a user of mobile phone 100 to control the implementation of the call waiting feature of mobile phone 100, as illustrated in FIG. 3, which is described in detail below. In an alternate embodiment, call waiting utility 120 may be implemented via a software program located within a server computer (not shown) connected to a network of cellular base stations controlled by a cellular telephone service provider. Similarly, call waiting utility 120 may instead be implemented via hardware components within mobile phone 100 and/or a network of cellular base stations.

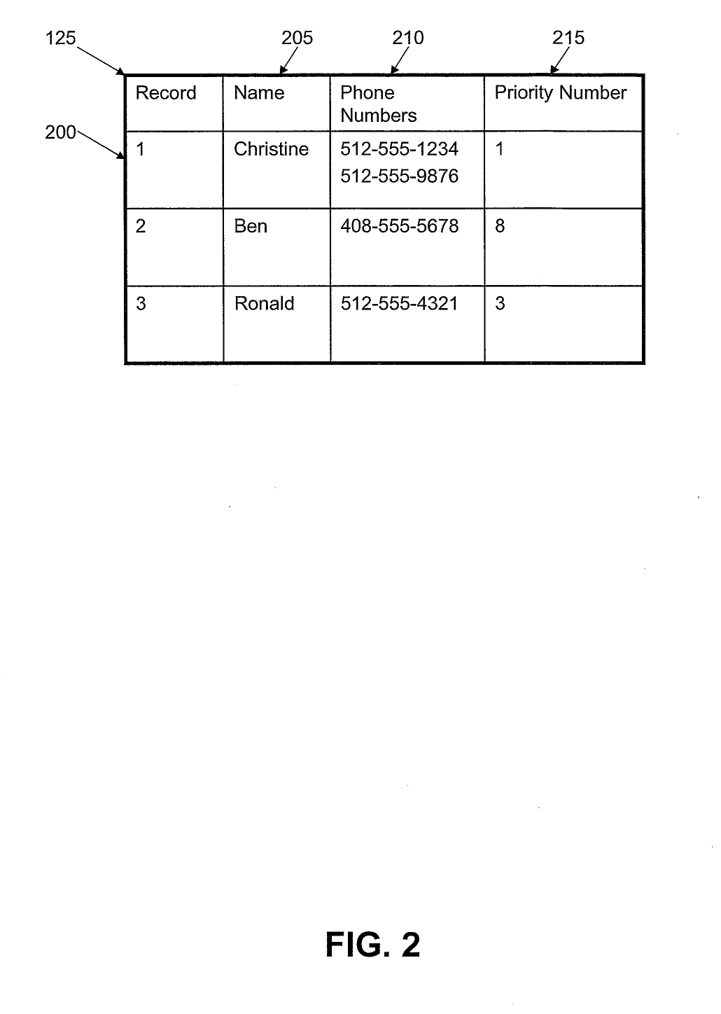

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

In one embodiment, and as further illustrated by FIG. 2, phone book 125 is an electronic database that contains multiple records 200. Each record 200 within phone book 125 is defined by a user of mobile phone 100 and includes information corresponding to a particular person or company known to the user of mobile phone 100. The information within each record 200 of phone book 125 includes, but is not limited to, the name 205 of the person or company, one or more telephone numbers 210, and a priority number 215.

Priority number 215 is an integer used to represent the priority level of a particular record 200 within phone book 125 with respect to the other records 200 within phone book 125. According to the illustrative embodiment, priority number 215 is an integer on a scale of 1 to 10, with 1 representing the highest priority, and 10 representing the lowest priority. A user of mobile phone 100 may thus define a particular record 200 within phone book 125 as being a high priority record for the purpose of call waiting by assigning record 200 a priority number 215 that has a low value. If a user of mobile phone 100 decides that multiple entries should have an equal priority level, the user may assign the same priority number 215 to one or more records 200.

In an alternate embodiment, priority numbers 215 may utilize a scale other than 1 to 10 and/or may be arranged such that a low values represent low priorities and high values represent high priorities. In another embodiment, a user of mobile phone 100 may assign an equivalent priority number 215 to a user-defined group of phone numbers 210. For example, a user may wish to assign numbers from a specific area code an equivalent priority level. A user may also utilize a graphical user interface (GUI) and key pad 140 to select from several pre-defined priority options for entries within phone book 125. In such an embodiment, a user may use key pad 140 to scroll through a list of available priority levels comprised of a range of integers (e.g., 1 through 10), words (e.g., high, medium, low), or colors (e.g., red, yellow, green).

With reference now to FIG. 3, there is illustrated a high level logical flowchart of an exemplary method of controlling the call waiting feature of a mobile phone, in accordance with one embodiment of the invention. The process begins at block 300 in response to a user of mobile phone 100 initiating or receiving a phone call, referred to herein as the current call. A determination is made at block 305 whether mobile phone 100 has received notification of a new incoming phone call, referred to herein as an incoming call.

If mobile phone 100 has not received notification of an incoming call, a decision is made whether the current call is still in progress, as shown in block 310. In response to a determination that the current call is still in progress, the process returns to block 305. If an incoming call has not been received and the current call is no longer in progress, the process terminates at block 345.

In response to a determination in block 305 that mobile phone 100 has received notification of an incoming call, call waiting utility 120 looks up priority number 215 of the incoming call by accessing the pre-set priority number 215 in record 200 within phone book 125 that corresponds to phone number 210 of the incoming call, as depicted in block 315.

A determination is made at block 320 whether call waiting utility 120 is able to locate a pre-set priority number 215 within phone book 125 that corresponds to phone number 210 of the incoming call. A pre-set priority number 215 may not exist for a specific phone number 210 within phone book 125 if the user has not previously set priority number 215 for that phone number 210, or if phone number 210 is not included within phone book 125. If call waiting utility 120 is not able to locate a pre-set priority number 215 for the incoming call for the reasons described above, call waiting utility 120 assigns a user-defined default priority number (e.g., 4) to the incoming call, as shown in block 325. The user-defined default priority number may be a mid-level priority (i.e., not high or low priority) allowing the incoming call an equal opportunity of being signaled to the user. In another embodiment, calls that do not have a pre-set priority number 215 are automatically signaled to the user, who may then be able to manually set an appropriate priority. The process then proceeds to block 330, which is discussed below.

If call waiting utility 120 is able to locate a pre-set priority number 215 within phone book 125 that corresponds to phone number 210 of the incoming call, a determination is made by call waiting utility 120 whether priority number 215 of the incoming call is less than or equal to priority number 215 of the current call, as depicted in block 330. According to the illustrative embodiment, high priority levels are represented by priority numbers 215 with low integer values.

In response to a determination that priority number 215 of the incoming call is not less than or equal to priority number 215 of the current call, call waiting utility 120 directs the incoming call to the mobile phone user's voicemail system, as shown in block 335. The process then terminates at block 345 and the user is notified of the missed call after the current call ends.

If priority number 215 of the incoming call is less than or equal to priority number 215 of the current call, call waiting utility 120 executes a conventional call waiting function and notifies the user about the incoming call, as shown in block 340. The process then terminates at block 345. In an alternate embodiment, the present invention may be implemented within a programmable non-mobile phone, which may be connected to the public switched telephone network (PSTN), or any other type of phone that can be programmed by the user, such as a voice over internet protocol (VOIP) phone. In another embodiment, a high priority level may be represented by a high value of priority number 215. In such an embodiment, a determination would instead be made at block 330 whether priority number 215 of the incoming call was greater than or equal to priority number 215 of the current call. The present invention thus enables a user of mobile phone 100 to control the automatic activation/deactivation of the call waiting feature in real time through the use of customized pre-set user preferences.

It is understood that the use herein of specific names are for example only and not meant to imply any limitations on the invention. The invention may thus be implemented with different nomenclature/terminology and associated functionality utilized to describe the above devices/utility, etc., without limitation.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. In a programmable phone device, a method comprising:
associating a priority characteristic to one or more entries within a phone book of the phone device;
when an incoming call from a second phone number is received during a current ongoing call with a first phone number having a pre-set priority characteristic, comparing the priority characteristic associated with the second phone number to the pre-set priority characteristic associated with first phone number;
when the second phone number has a priority characteristic that is at least as high as that of the first phone number, enabling a call waiting response wherein a signal is generated indicating that the incoming call is being receiving at the phone device, wherein a user of the phone device may elect to answer the incoming call in response to the call waiting signal; and
when the second phone number has a lower priority characteristic than the first phone number and the phone device includes access to a voicemail, automatically forwarding the incoming call to the voicemail of the phone device, wherein a receipt of the incoming call is not signaled to the user of the phone device during the current ongoing call.

2. The method of claim 1, wherein said associating further comprises:
assigning a priority tag indicative of the priority characteristic of the one or more entries within a phone book; and
storing the priority tag within a record corresponding to the respective entry among the one or more entries within the phone book.

3. The method of claim 1, wherein the priority characteristic is a priority number assigned to selected entries within the phone book, said method comprising:
enabling specific assignment of one of a plurality of numbers within a number scale representing a range from a high priority to a low priority; and
said comparing the priority characteristics further comprises comparing a pre-set priority number within said phone book corresponding to the first phone number of the current ongoing call to the priority number corresponding to the second phone number of the incoming call in response to a detection by said mobile phone of said incoming call while the user is making or engaged in said current ongoing call.

4. The method of claim 1, wherein:
said comparing further comprises:
on receipt of said incoming call, checking the phone book for an entry of the second phone number and an associated priority characteristic;
assigning a default priority characteristic to the second phone number of said incoming call when one or more trigger conditions results from said checking, said trigger conditions including: (a) said checking results in a first determination that said second phone number is not an entry within the phone book; and (b) said checking results in a second determination that said second phone number does not have an associated priority characteristic;
said triggering of said call waiting response comprises notifying the user of said incoming call when said default priority characteristic assigned to said incoming call is at least as high as the pre-set priority characteristic of said current ogoing call; and
said automatically forwarding comprises directing said incoming call to the voicemail of the phone device without interrupting said current ongoing call when said default priority characteristic of said incoming call has a lower priority than said pre-set priority of said current ongoing call.

5. The method of claim 1, further comprising:
generating and displaying a user interface that enables selection by a user of the priority characteristic to assign to the one or more entries of the phone book;
receiving an entry of the priority characteristic via a user input.

6. The method of claim 5, wherein the step of generating and displaying the user interface comprises providing within the user interface a priority scale representing the range of possible priority characteristics that may selectively be assigned to selected entries within the phone book, wherein said priority scale includes priorities ranging from a high priority to a low priority.

7. The method of claim 1, further comprising:
when an incoming call from a second phone number is received during a current ongoing call with a first phone number that does not have a pre-set priority characteristic,
dynamically assigning a default medium-level priority characteristic to the first phone number of the current ongoing call; and
comparing the priority characteristic associated with the second phone number to the default medium-level priority characteristic assigned to the first phone number.

8. A programmable phone device comprising:
a processor;
a memory having stored therein a phone book that contains a plurality of records corresponding to telephone numbers; and
a call waiting utility within said system memory that provides means for enabling a priority tag indicating a call-waiting priority characteristic to be assigned to one or more of the plurality of records within said phone book;
wherein said priority tag enables the utility to selectively activate and deactivate a call-waiting signaling function of said phone device based on the priority tag assigned to a record corresponding to a second phone number of an incoming call that is received during an ongoing call with a first phone number having a pre-set priority tag.

9. The phone device of claim 8, wherein said call waiting utility further comprises:
means for receiving input of a selection of a priority tag to assign to the one or more records;
means for associating the priority characteristic to one or more entries within a phone book of the phone device via storing the priority tag along with the respective one or more entries;
when an incoming call from a second phone number is received during a current ongoing call with a first phone number having a pre-set priority tag, means for comparing the priority characteristic associated with the second phone number to the pre-set priority characteristic associated with first phone number;
when the second phone number has a priority characteristic that is at least as high as that of the first phone number, means for enabling a call waiting response wherein a signal is generated indicating that the incoming call is being receiving at the phone device, wherein a user of the phone device may elect to answer the incoming call in response to the call waiting signal; and
when the second phone number has a lower priority characteristic than the first phone number and the phone device includes access to a voicemail, means for automatically forwarding the incoming call to the voicemail of the phone device, wherein a receipt of the incoming call is not signaled to the user of the phone device during the current ongoing call.

10. The phone device of claim 9, wherein said utility further comprises:
means for generating and displaying a user interface that enables selection by a user of the priority characteristic to assign to the one or more entries of the phone book; and
means for providing within the user interface a priority scale representing the range of possible priority characteristics that may selectively be assigned to selected entries within the phone book, wherein said priority scale includes priorities ranging from a high priority to a low priority.

11. The phone device of claim 9, wherein the priority characteristic is a priority number assigned to selected entries within the phone book, said utility further comprising:
means for enabling specific assignment of one of a plurality of numbers within a number scale representing a range from a high priority to a low priority; and
said means for comparing the priority characteristics further comprises means for comparing a pre-set priority number within said phone book corresponding to the first phone number of the current ongoing call to the priority number corresponding to the second phone number of the incoming call in response to a detection by said mobile phone of said incoming call while the user is making or engaged in said current ongoing call.

12. The phone device of claim 9, wherein:
said means for comparing further comprises:
on receipt of said incoming call, means for checking the phone book for an entry of the second phone number and an associated priority tag;
means for assigning a default priority characteristic to the second phone number of said incoming call when one or more trigger conditions results from said checking, said trigger conditions including: (a) said checking results in a first determination that said second phone number is not an entry within the phone book; and (b) said checking results in a second determination that said second phone number does not have an associated priority tag;
said means for triggering of said call waiting response comprises means for notifying the user of said incoming call when said default priority characteristic assigned to said incoming call is at least as high as the pre-set priority characteristic of said current ogoing call; and
said means for automatically forwarding comprises means for directing said incoming call to the voicemail of the phone device without interrupting said current ongoing call when said default priority characteristic of said incoming call has a lower priority than said pre-set priority of said current ongoing call.

13. The phone device of claim 9, wherein said utility further comprises:
when an incoming call from a second phone number is received during a current ongoing call with a first phone number that does not have a pre-set priority characteristic,
means for dynamically assigning a default medium-level priority characteristic to the first phone number of the current ongoing call; and
means for comparing the priority characteristic associated with the second phone number to the default medium-level priority characteristic assigned to the first phone number.

14. A computer program product comprising:
a computer readable medium; and
program code on said computer readable medium that that when executed provides the functions of:
associating a priority characteristic to one or more entries within a phone book of the phone device;
when an incoming call from a second phone number is received during a current ongoing call with a first phone number having a pre-set priority characteristic, comparing the priority characteristic associated with the second phone number to the pre-set priority characteristic associated with first phone number;
when the second phone number has a priority characteristic that is at least as high as that of the first phone number, enabling a call waiting response wherein a signal is generated indicating that the incoming call is being receiving at the phone device, wherein a user of the phone device may elect to answer the incoming call in response to the call waiting signal; and
when the second phone number has a lower priority characteristic than the first phone number and the phone device includes access to a voicemail, automatically forwarding the incoming call to the voicemail of the phone device, wherein a receipt of the incoming call is not signaled to the user of the phone device during the current ongoing call.

15. The computer program product of claim 14, wherein said program code for completing said associating further comprises code for:
assigning a priority tag indicative of the priority characteristic of the one or more entries within a phone book; and
storing the priority tag within a record corresponding to the respective entry among the one or more entries within the phone book.

16. The computer program product of claim 14, wherein the priority characteristic is a priority number assigned to selected entries within the phone book, said program code further comprising code for:
enabling specific assignment of one of a plurality of numbers within a number scale representing a range from a high priority to a low priority; and
wherein said code for comparing the priority characteristics further comprises code for comparing a pre-set priority number within said phone book corresponding to the first phone number of the current ongoing call to the priority number corresponding to the second phone number of the incoming call in response to a detection by said mobile phone of said incoming call while the user is making or engaged in said current ongoing call.

17. The computer program product of claim 14, wherein:
said program code for comparing further comprises code for:
on receipt of said incoming call, checking the phone book for an entry of the second phone number and an associated priority characteristic;
assigning a default priority characteristic to the second phone number of said incoming call when one or more trigger conditions results from said checking, said trigger conditions including: (a) said checking results in a first determination that said second phone number is not an entry within the phone book; and (b) said checking results in a second determination that said second phone number does not have an associated priority characteristic;
said program code for triggering of said call waiting response comprises code for notifying the user of said incoming call when said default priority characteristic assigned to said incoming call is at least as high as the pre-set priority characteristic of said current ongoing call; and
said program code for automatically forwarding comprises code for directing said incoming call to the voicemail of the phone device without interrupting said current ongoing call when said default priority characteristic of said incoming call has a lower priority than said pre-set priority of said current ongoing call.

18. The computer program product of claim 14, further comprising program code for:
generating and displaying a user interface that enables selection by a user of the priority characteristic to assign to the one or more entries of the phone book;
receiving an entry of the priority characteristic via a user input.

19. The computer program product of claim 18, wherein the code for generating and displaying the user interface comprises code for providing within the user interface a priority scale representing the range of possible priority characteristics that may selectively be assigned to selected entries within the phone book, wherein said priority scale includes priorities ranging from a high priority to a low priority.

20. The computer program product of claim 14, further comprising code for:
when an incoming call from a second phone number is received during a current ongoing call with a first phone number that does not have a pre-set priority characteristic,
dynamically assigning a default medium-level priority characteristic to the first phone number of the current ongoing call; and
comparing the priority characteristic associated with the second phone number to the default medium-level priority characteristic assigned to the first phone number.
